(19) United States
(12) Patent Application Publication
(10) Pub. No.: US 2003/0112344 A1
(43) Pub. Date: Jun. 19, 2003

(54) Digital still camera

(75) Inventor: Tsuneo Sato, Saitama (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/321,768

(22) Filed: Dec. 18, 2002

(30) Foreign Application Priority Data
Dec. 19, 2001 (JP) 2001-385553

(51) Int. Cl. H04N 5/76

(52) U.S. Cl. 348/231.3

(57) ABSTRACT

In a digital still camera is loaded a removable memory in which plural messages according to an object are memorized. When the photography is made, an elapsed time calculated from a reference date and a photography time is compared with effective elapsed time regions provided to the respective messages. Only the messages corresponding to the effective elapsed time region containing the elapsed time are displayed on the display. At least one of the displayed messages is synthesized with a photographed image so as to form a synthesized image. The synthesized image is memorized in the memory.

### BACKGROUND OF THE INVENTION

1. Field of the Invention

The present invention relates to a digital still camera which can synthesize a literal image with a photographed image.

2. Description Related to the Prior Art

A digital still camera is known that can synthesize a literal image, such as a message, a date information and the like, with a photographed image, for recording an information which only the photographed image cannot represent. By synthesizing the literal image with the photographed image, it becomes easily to sort the photographed image, and when the date information is synthesized, the variation of the object in accordance with the time is recorded.

The forming of the literal image is carried out by inputting a literal image data. For example, the digital still camera disclosed in Japanese Patent Laid-Open Publication No. 2000-217034 is provided with a pressure sensitive panel, which data of letters can be input into by writing the letters with hands. In Japanese Patent Laid-Open Publication No. 2001-157163, the digital still camera receives a literal image data from a portable telephone in which the letters are input by operating a ten key. Further, there is a type of the digital still camera in which the literal image data obtained from a voice signal by recognizing a voice through a microphone can be input.

It is convenient to edit such the literal image to be synthesized with the photographed image as one likes. However, the editing of the literal image causes to lose much time and to enlarge the digital still camera. Further, a device for inputting the data of letter must be carried. In the digital, still camera disclosed in Japanese Patent Laid-Open Publication No. 2001-8143, plural literal image patterns are previously memorized in a memory, and are selected by a user. The selected literal image patterns are synthesized with date information based on a reference date to construct a literal image. Then the literal image is synthesized with the photographed image, and they are displayed. The digital still camera is excellent in the portability and the easiness of operation of input, and especially effective for recording the objects having a relation to a commonality to passage of time, such as the growth of children and the process of work in a construction field.

However, in this digital still camera, it is impossible to carry out the input of such literal data as a user wishes. Further, when it is designated to increase the kind of messages, the number of literal image patterns in the memory becomes larger. Accordingly the number of the literal patterns displayed on the literal pattern is increased during editing the message. Accordingly, much time is lost for selecting the massage to be recorded, which make smooth input of the literal pattern hard.

### SUMMARY OF THE INVENTION

An object of the present invention is to provide a digital still camera in which a message is easily edited as a literal image to be synthesized with a photographed image.

Another object of the present invention is to provide a digital still camera in which a message in a relation with a date of photography is synthesized as a literal image with a photographed image.

In order to achieve the objects and the other objects, a digital still camera of the present invention is provided with a memory in which plural messages are recorded. Each of the message is provided with an effective elapsed time region or allowable time condition.

The digital still camera includes a calculate section, which calculates an elapsed time between a reference date set before photography and a photographing date on basis of data sent from a clock section. After photography, a reading means reads out messages to compare the effective elapsed time of the respective messages with the elapsed time. At least one of the messages corresponding to the effective elapsed time regions containing the elapsed time is selected with a selecting means. Then a synthesized image in which the at least one messages is synthesized with the photographed image is memorized in a storing section.

In the digital still camera of the present invention, the memory is removable. The memory is provide with a theme, and only the message according to the theme are memorized in the memory.

According to the digital still camera of the present invention, the elapsed time is compared with the effective elapsed time region to decrease the number of the messages displayed on the monitor during editing. Accordingly the edit of the message is easily carried out. Further, as the memory is removable, the kind of the editable messages increases without increasing the number of the message patterns displayed on the monitor during editing.

### BRIEF DISCRIPTION OF THE DRAWINGS

The above objects and advantages of the present invention will become easily understood by one of ordinary skill in the art when the following detailed description would be read in connection with the accompanying drawings.

FIG. 1 is a perspective front view of a digital still camera of the present invention;

FIG. 2 is a perspective rear view of the digital still camera of FIG. 1;

FIG. 3 is a plan view of a mode changer in the digital still camera;

FIG. 4 is a block diagram of the digital still camera;

FIG. 5 is a chart of messages and regions of numbers of elapsed days;

FIG. 6 is a flow chart of operations in a setting mode;

FIG. 7A is an explanatory view illustrating a display of a LCD monitor in a setting mode;

FIG. 7B is an explanatory view illustrating a display of a LCD monitor in a photography mode;

FIG. 7C is an explanatory view illustrating a display of a LCD monitor when in setting a birthday;

FIG. 8 is a flow chart illustrating an operation in the photography mode;

FIG. 9A is an explanatory view illustrating a situation in which a photographed image is displayed;

FIG. 9B is an explanatory view illustrating a display when in selecting a message;

FIG. 9C is an explanatory view illustrating a situation in which the literal image and the photographed image are synthesized.

### PREFERRED EMBODIMENTS OF THE INVENTION

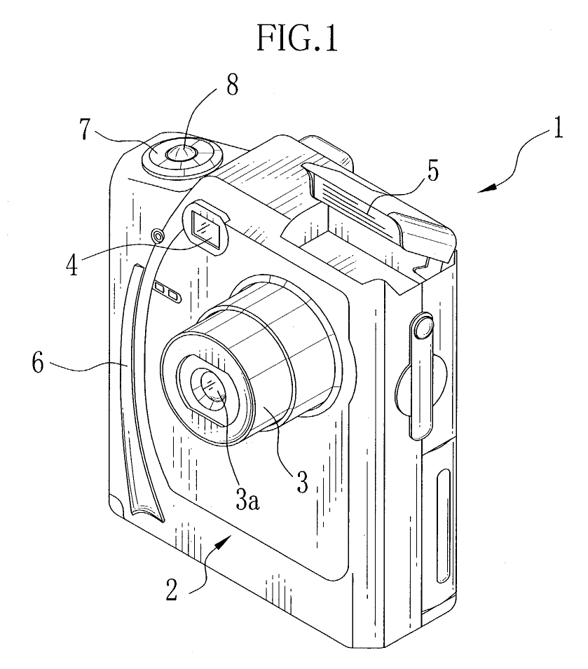

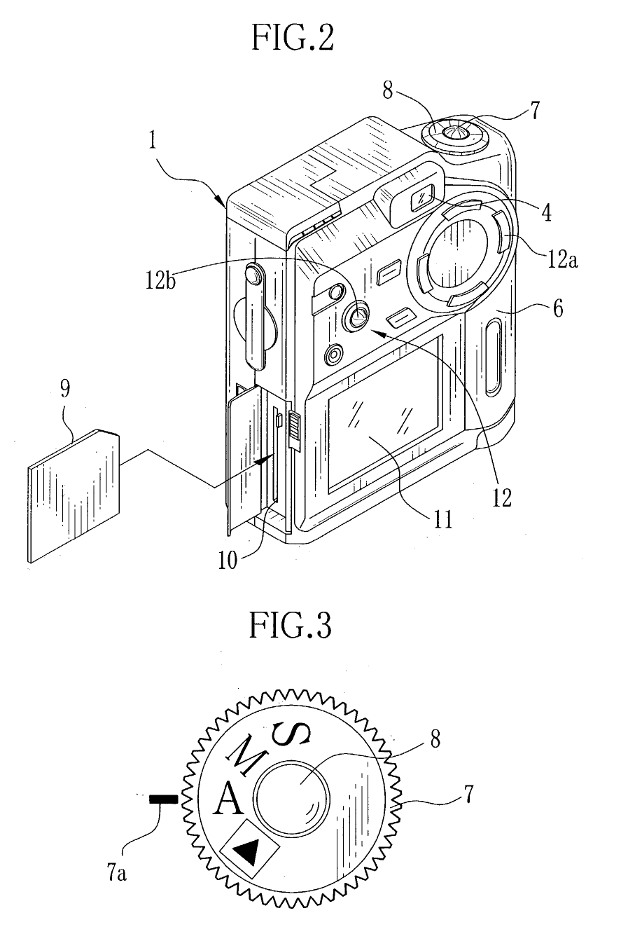

In FIG. 1, a digital still camera 1 has a nearly rectangular camera body 2, which is provided with a lens barrel 3, a view finder 4 and a flashlight emitter 5. In the lens barrel 3, a taking lens 3a is provided. Behind the taking lens 3a are disposed CCD elements (not shown) for receiving light of an object that is formed by the taking lens 3a. Further, a mode changer or dial 7 is provided on the top of a grip 6 of the camera body 2. At a center of the mode changer 7 there is a shutter button 8. As shown in FIG. 2, the camera body 2 has a slot 10 through which a memory card 9 is inserted. Behind the camera body 2, there are a liquid crystal monitor (LCD) 11 or display panel and an externally operable selector 12 provided with several buttons, such as a cross-shaped key 12a and a determination button 12b.

In FIG. 3, signs or letters “S”, “M”, “A” and a triangle mark are arranged on the mode changers 7. When the mode changer 7 is operated, the mode of the digital camera 1 is changed. While the sign “S” confronts to the set line 7a, the digital still camera 1 is set to a setting mode in which date and time in the clock can be exactly adjusted and it can be determined whether to form a synthesized image in which the literal image is synthesized with the photographed image. When the sign “M” confronts to the set line 7a, the digital still camera 1 is set to a manual photography mode in which the adjustment of focusing and exposure may be manually carried out. Further, when the sign “A” confronts to the set line 7a, an auto-focusing photography is carried out, by which the auto-focusing and the program shutter are used. When the triangle mark of the mode changer 7 confronts to the set line 7a, an image data stored in the memory card 9 is read out to display the photographed image or the synthesized image on the liquid crystal monitor 11.

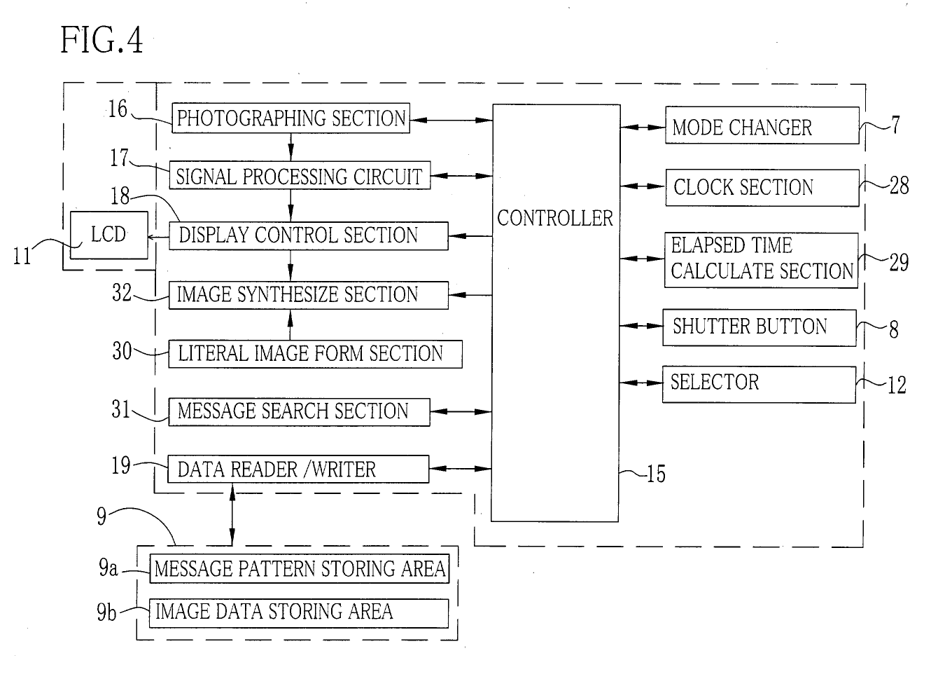

In FIG. 4, a controller 15 outputs a control signal to each element, with responding to an operation signal sent from the mode changer 7, the shutter button 8 and the selector 12. A photographing section 16 or image sensor section is constructed of the CCD elements and a CCD drive controller for driving the CCD elements. The CCD elements photoelectrically transform optical image of the objects that is formed through the taking lens, and then generates a photographing signal and to send it to a signal processing circuit 17. The photographing signal is amplified to a predetermined level in the signal processing circuit 17, and then processed in the signal processing such as a white balance adjustment and γ compensation is carried out, and thereafter is transformed into a photographed image data.

The photographed image data output from the signal processing circuit 17 is sent to a display control section 18 such that the image of the object is continuously displayed on the liquid crystal monitor 11. When the shutter button 8 is depressed, the photographed image of the object is sequentially displayed on the liquid crystal monitor 11. Further, the determining button 12b of the selector 12 is depressed, the photographed image data is sent to an image synthesize section 32.

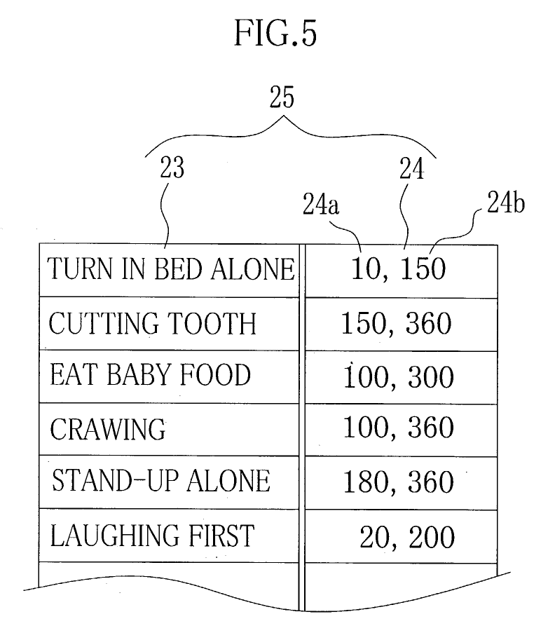

A data reader/writer 19 reads data from and writes data to the memory card 9. The memory card 9 has a message pattern storing area 9a and an image data storing area 9b. The message pattern storing area 9a stores message patterns 25 or message table data (see FIG. 5). Each of the message patterns 25 consists of message data 23 and search parameters 24 which it is prohibited to rewrite and eliminate. When it is not designated to synthesize the literal image with the photographed image, the photographed image data of the photographed image stationarily displayed is stored in the image data storing area 9b.

When it is designated to synthesize the literal image with the photographed image, the controller 15 actuates the clock section 28, an elapsed time calculate section 29, a literal image form section 30, a message search section 31 and an image synthesize section 32, sequentially. The clock section 28 outputs present date information generated by measurement of time after the date and time exactly set in the setting mode. The elapsed time calculate section 29 calculates the elapsed time (elapsed time period) from the reference date to the photo date so as to output an elapsed time data. The photographing date information, the elapsed time and the message data 23 of the message to be synthesized with the photographed image are input in the literal image form section 30, such that a literal image data may be generated.

The message search section 31 reads all of the message patterns from the message pattern storing area 9a and searches the message patterns in accordance with the elapsed time. In searching, the search parameters 24 as elapsed time region data are compared with the elapsed time data. The message data 23 whose search parameters 24 define a time condition satisfied by the elapsed time is sent to the controller 15. Then the controller 15 sends the message data 23 to the display control section 18, and selection messages corresponding to the message data 23 are displayed on the liquid crystal monitor 11.

The message search section 31 outputs the message data 23 of the selected message to the literal image form section 30, by operation through an operation member. The literal image form section 30 generates the literal image data from the photographing date information, the elapsed time data and the message data of the selected message to send the literal image data to the image synthesize section 32. The image synthesize section 32 changes a part of pixels of the photographed image to the literal image data to synthesize the literal image and the photographed image, and to store them in the image data storing area 9b together.

As shown in FIG. 5, in the present embodiment, the message data 23 is a data according to the growth of baby. In this figure, the messages corresponding to the respective message data 23 are illustrated. In the elapsed time calculate section 29 the birthday of baby is memorized as a reference date. The search parameters 24 are used for search of the message data 23 based on the elapsed time data. The search parameters 24 correspond to the respective message data 23 to determine the searched region between a minimum day number 24a and a maximum day number 24b. The minimum day number 24a and the maximum day number 24b are predetermined on the base of general data about growth of baby with considering the difference thereof between individuals. For example, the message “turn in bed alone” is memorized in association with a baby's age in a range of 10-150 days.

If the elapsed time is detected to satisfy one or more conditions defined between the minimum and maximum day numbers 24a and 24b of the search parameters 24, then the messages associated with these search parameters 24 are extracted and displayed. Supposing that the elapsed time of the photographed image is 120 days, as the elapsed time is between the minimum day number 24a and the maximum day number 24b, the following preliminary selective messages are displayed: “turn in the bed alone”, “eat the baby food”, “crawling”. Otherwise the message “stand up alone” is not displayed, whose searched region is 180-360 days. Further, the message “turn in the bed alone” whose maximum day number 24b is 150 and the message “stand up alone” whose minimum day number 24b is 180 are not displayed at the same time.

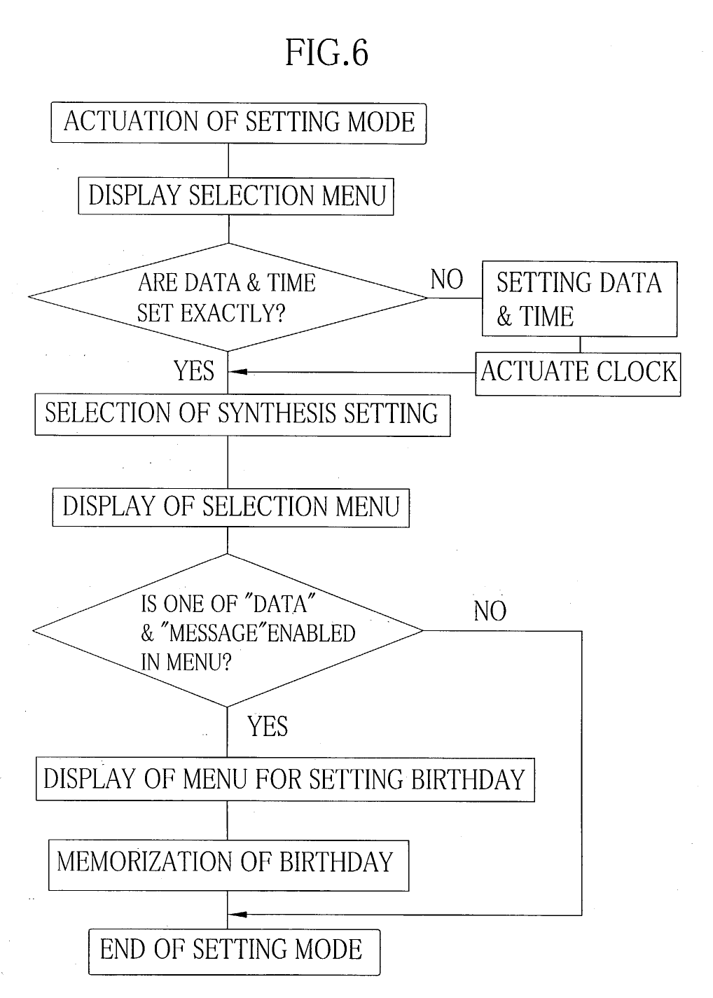

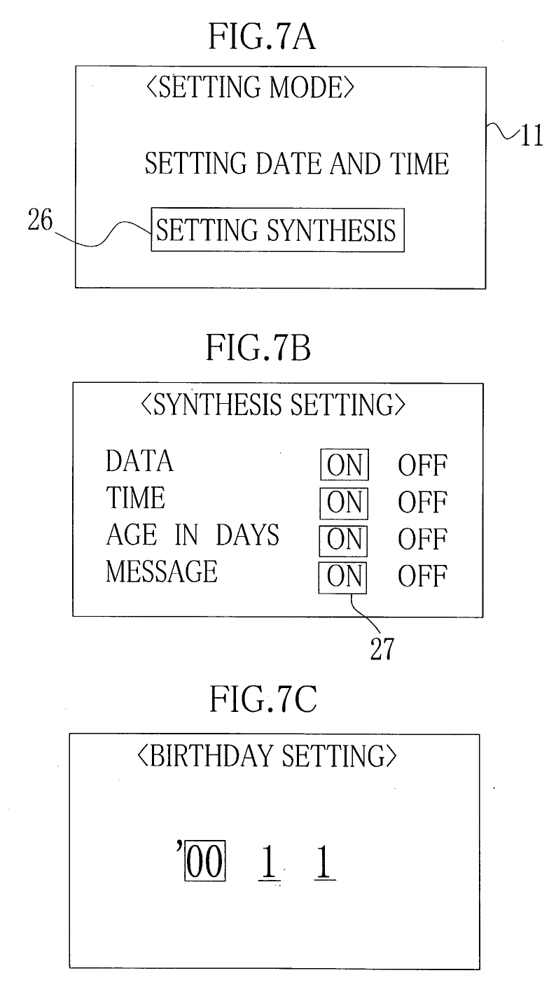

Operations of the digital still camera 1 of the present invention will be described now with use of the flow chart of FIG. 6. When the baby is photographed as the object, the memory card 9 in which the message patterns 25 are stored is inserted in the slot 10, and a power switch of the digital still camera 1 is turned on. When the mode changer 7 is operated such that the sign “S” may confront to the set line 7a, the camera is set in the setting mode. Then, as shown in FIG. 7A, the two options “date and time setting” in the clock and “synthesis setting” are displayed. When the exact setting of date and time is not carried out yet, the option “date and time setting” is selected. The date and time are initially input by operating the cross-shaped key 12a, so the clock section 28 starts operation.

After the information of date and time is exactly input by operating the cross key 12a, the synthesis setting is selected, so four selection menus are displayed: “time”, “date”, age in days” and “message”. When the options “age in days” as the elapsed time period or the “message” are selected, the image for setting the birthday is displayed. After input of the birthday, the data thereof is stored in the elapsed time calculate section 29 to make an end of the setting mode. Note that the setting mode is canceled also when the synthesis setting is not selected.

Note that in FIG. 7A, when the cross key 12a is operated to make the selection of the options, a position of a square designated area 26 is changed between the synthesis setting and the date and time setting. Further, as shown in FIG. 7B, when the cross key 12a is operated to make the selection of the selection menus, a position of a square designated area 27 is changed between ON and OFF in each selection menu. Furthermore, in FIG. 7C, the numbers are input for setting the birthday.

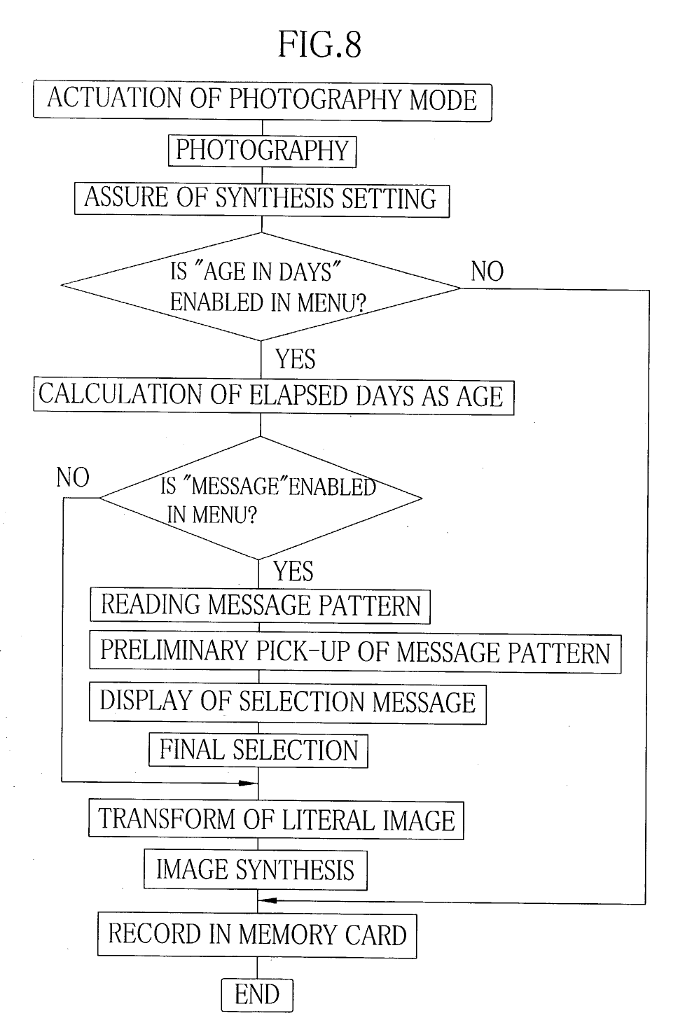

After canceling the setting mode, the mode changer 7 is rotated such that the sings “A” or “M” confront to the setting line 7a, and the digital still camera 1 is set to a photography mode. Thereafter, in FIG. 8, when the photography of the baby is made by pressing the shutter button 8, the setting of synthesizing is checked. When the option “age in days” is set to ON, the controller 15 drives the elapsed time calculate section 29 to make a calculation of the elapsed time and to output an elapsed time data. The elapsed time data, when combined with the photographing date information for the date and time to form a literal image data to be synthesized with the photographed image. Then the synthesized image is displayed on the liquid crystal panel 11 and the image data of the synthesized image is memorized in the memory card 9.

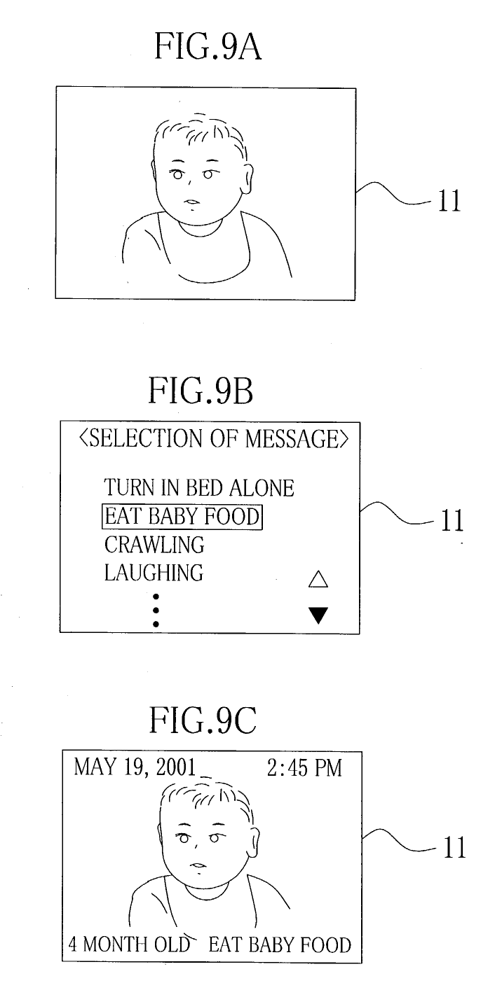

Further, when the option “message” is set to ON, the photographed image of the object is displayed on the liquid crystal panel 11 for a predetermined time (FIG. 9A), and data of the elapsed time data is sent to the message search section 31. In the message search section 31, the messages are preliminary selected, and thereafter the selection messages are displayed on the liquid crystal panel 11. Specifically, one or more of the plural time region data are extracted in association with the elapsed time or number of elapsed days, the plural time region data being the plural pairs of the search parameters 24. Then one or more of the message data 23 are designated and output according to the extracted time region data (See, FIG. 9B). The number of the selection messages displayed on the liquid crystal panel 11 is smaller than the total number of the messages memorized in the memory card 9. Accordingly, the final selection of the messages is made easily.

Then a literal image is formed from the message data of the finally selected message, the photographing date information and the elapsed time data, and synthesized with the photographed image to form the synthesized image. The synthesized image is displayed on the liquid crystal panel (FIG. 9C) and recorded in the memory card 9.

Note that when the setting is not made in the setting mode of “age in days” or “message”, only the photographed image is memorized in the memory card 9. Further, a mode in which all of the messages are displayed may be provided, in addition to the above-described mode in which only the preliminarily selected messages are displayed on the liquid crystal panel 11.

In the above embodiment, the messages of the growth of baby are memorized in the memory card. However, the present invention is not restricted in it. Messages adequate for observation of plants or insects or for procedure of work may be memorized. When a record of the observation is made, the date of seeding for recording the observation of plants, the date of hatching or birthday for observing of animals, or the date of starting work for recording the procedure thereof can be set as the reference date. In these cases, when the memory card is changed, kinds of the literal images to be synthesized with the photographed image in the digital still camera become more. Further, the plural messages may be recorded in the one photographed image.

Further, the elapsed time may be represented not only by a unit of date but also that of hour, month or year. Furthermore one photographed image may be synthesized with plural messages.

When the memory card for the growth of children or the observation of organism is used, information of childcare or a breed may be synthesized as the message. In this case, a degree of the growth is calculated from a data of the elapsed time, and the messages about cautions and advices are displayed on the liquid crystal panel. Further, when the memory card for recording the growth of children is used, the messages stored in the memory card may be about the events in a year (for example, new year, halloween, thanksgiving day and Christmas) or about the celebration on birthday. In this case, the selection messages to be displayed are determined on basis of the date of photography.

In the above embodiment, the synthesized image of the photographed image and the literal image is memorized in the memory card. However, the literal image data may be stored in the memory card in a relation of the photographed image data, and they may be synthesized after reading out from the memory card. The memory area of the memory card may have a region for relating the photographed image information with the literal image information. The literal image information may be written in the Exif (Exchangeable image file) information part of image data file.

Further, the message pattern may be stored in an internal memory incorporated in the digital still camera, instead of the memory card as the outer storing medium.

Various changes and modifications are possible in the present invention and may be understood to be within the present invention.

What is claimed is:

1. A digital still camera for outputting a synthesized image in which an object image of an object taken by photography operation is combined with a literal image including a message, said digital still camera comprising:
a clock section for generating photographing date information representing photographing date of photography of said object;
an elapsed time calculating section for calculating an elapsed time from a reference date which is previously set, to said photographing date;
a memory for storing plural message data and an elapsed time region data which corresponds to each of said message data;
a data reader for reading out said message data, said reader comparing said elapsed time with an elapsed time region which said elapsed time region data represents, and outputting as said message at least one of said message data corresponding to said elapsed time region data whose condition said elapsed time satisfies; and
an image synthesizing section for synthesizing said object image with said output message.

2. A digital still camera according to claim 1, further comprising a display section for displaying said message, said data reader outputting said message data to said display section only when said elapsed time region which said elapsed time region data represents includes said elapsed time.

3. A digital still camera as claimed in claim 2, further comprising a selector for selecting at least one of said one or more messages displayed on said display section.

4. A digital still camera as claimed in claim 2, wherein said literal image includes said photographing date and said elapsed time.

5. A digital still camera according to claim 2, wherein said memory is set removably.

6. A digital still camera according to claim 5, wherein said messages having the same theme are memorized in said memory as said message data.

7. A digital still camera according to claim 5, wherein said synthesized image is memorized in said memory.

8. A digital still camera according to claim 5, wherein said object image and said literal image corresponding to said object image are memorized in said memory.

9. A memory card removably attached to a digital still camera, said digital still camera generating an object image formed through photography to output to a display section, and calculating an elapsed time from a predetermined reference date to a photographing date, said memory card comprising:
plural message data;
an elapsed time region data corresponding to each of said message data, said message data being output to said display section as a message only when a condition of an elapsed time region represented by said elapsed time region data is satisfied by said elapsed time.

10. A memory card according to claim 9, wherein at least one of said one or more messages displayed on said display section is selected and synthesized with said object image to form a synthesized image, and said synthesized image is memorized.

11. A memory card according to claim 9, wherein said messages having the same theme are memorized.
